(19) United States
(12) Patent Application Publication
(10) Pub. No.: US 2024/0301157 A1
(43) Pub. Date: Sep. 12, 2024

(54) BLOWING AGENTS FOR THERMOPLASTIC FOAM, THERMOPLASTIC FOAMS AND METHODS OF FOAMING

(71) Applicant: HONEYWELL INTERNATIONAL INC., Charlotte, NC (US)

(72) Inventor: Syed Hassan Mahmood, Buffalo, NY (US)

(73) Assignee: HONEYWELL INTERNATIONAL INC., Charlotte, NC (US)

(21) Appl. No.: 18/597,820

(22) Filed: Mar. 6, 2024

Related U.S. Application Data
(60) Provisional application No. 63/450,681, filed on Mar. 8, 2023.

(51) Int. Cl. C08J 9/14

(52) U.S. Cl. CPC C08J 9/149; C08J 2201/03; C08J 2203/14; C08J 2203/162; C08J 2205/052; C08J 2325/06

(57) ABSTRACT

Methods for forming extruded polystyrene foam comprising: (a) providing a thermoplastic melt and a blowing agent in the melt comprising: (1) from about 10% by weight to about 50% by weight of HCFO-1233zd(E); (2) from about 35% by weight to about 75% by weight of HFC-134a; (3) from about 10% to about 30% by weight of isobutane; and (4) optionally up to about 15% by weight of dimethyl ether; and (b) foaming the thermoplastic material.

### CROSS REFERENCE TO RELATED APPLICATION

This application is related to and claims the priority benefit of U.S. Provisional Application No. 63/450,681, filed Mar. 8, 2023, which is incorporated by reference herein in its entirety.

### FIELD OF THE INVENTION

This invention relates to compositions, methods and systems having utility in connection with extruded thermoplastic foams, including particularly in connection with blowing agents, foamable compositions, foams and articles made with or from polystyrene foams.

### BACKGROUND

Certain fluorocarbon fluids have found widespread use as blowing agents. Because of environmental problems (including relatively high ozone depletion potentials) associated with the use of some of these fluorocarbon fluids, it has become increasingly desirable to use fluids having low or even zero ozone depletion potential, such as hydrofluorocarbons (“HFCs”). However, some HFC fluids may have relatively high global warming potentials associated therewith, and it is desirable to use hydrofluorocarbon or other fluorinated fluids having low ozone depletion potential and low global warming potential while maintaining the desired performance properties of the foam.

In terms of performance properties of the foam, it is considered important in many cases that the foam possess excellent thermal insulating properties and other desirable foam characteristics. Another foam characteristic that is important in many applications is the density of the foam. For example, there is a need in many thermal insulating foam applications to have a foam that not only exhibits a low thermal conductivity, but also a relatively low foam density.

A significant challenge has been encountered in efforts to achieve thermoplastic foams that at once have low thermal conductivity (measured after ageing) and low density, and in particular to the achievement of thermoplastic polystyrene foam with a density of less than 40 kg/m³ and at the same time an aged thermal conductivity of 29.5 mW/mK or less.

There has thus been an increasing need for new blowing agent materials that are attractive alternatives to the compositions heretofore used as blowing agents in these and other applications. Applicants have thus recognized a need for new blowing agent compositions that offer effective alternatives to, and are considered environmentally safer substitutes for, previously used blowing agents to make low density, low thermal conductivity thermoplastic foams, and extruded polystyrene foam in particular.

The use of halogenated olefin blowing agents, including hydrofluoroolefins (HFOs) and hydrochlorofluorolefins (HCFOs), is also known, as disclosed for example in US 2009/0305876, which is assigned to the assignee of the present invention and which is incorporated herein by reference.

Notwithstanding the disclosures in the '876 publication, applicants have come to appreciate that an unexpected advantage can be achieved in connection with the formation of extruded thermoplastic foams, and in particular extruded polystyrene foams, by using a carefully selected combination of blowing agent components in carefully selected amounts, as explained in detail hereinafter.

### SUMMARY

The present invention includes blowing agent formulations for producing thermoplastic foams with excellent thermal insulating properties (including preferably low initial and delta lambda (as defined hereinafter)) and low foam density, said blowing agent formulation comprising:
(a) from about 10% by weight to about 50% by weight of HCFO-1233zd(E);
(b) from about 30% by weight to about 65% by weight of HFC-134a;
(c) from about 10% to about 30% by weight of isobutane;
(d) optionally up to about 15% by weight of dimethyl ether; and
(e) optionally up to about 10% by weight of CO2 or water or ethanol or a combination of these,
   wherein the amount of components (a)-(e) in the blowing agent is not less than about 95% by weight of all the blowing agents components in the formulation. For the purposes of convenience, blowing agents in accordance with this paragraph are referred to herein as Blowing Agent 1A1.

The present invention includes blowing agent formulations for producing thermoplastic foams with excellent thermal insulating properties (including preferably low initial and delta lambda (as defined hereinafter)) and low foam density, said blowing agent formulation comprising:
(a) from about 10% by weight to less than 35% by weight of HCFO-1233zd(E);
(b) from about 30% by weight to about 65% by weight of HFC-134a;
(c) from about 15% to about 25% by weight of isobutane;
(d) optionally up to about 20% by weight of a fourth component comprising dimethyl ether or carbon dioxide or water or ethanol or a combination of these,
   wherein the amount of components (a)-(d) in the blowing agent is not less than about 95% by weight of all the blowing agents components in the formulation. For the purposes of convenience, blowing agents in accordance with this paragraph are referred to herein as Blowing Agent 1A2.

The present invention includes blowing agent formulations for producing thermoplastic foams with excellent thermal insulating properties (including preferably low initial and delta lambda (as defined hereinafter)) and low foam density, said blowing agent formulation comprising:
(a) from about 10% by weight to about 30% by weight of HCFO-1233zd(E);
(b) from about 35% by weight to about 65% by weight of HFC-134a;
(c) from about 10% to about 30% by weight of isobutane; and
(d) optionally up to about 20% by weight of a fourth component comprising dimethyl ether or carbon dioxide or water or ethanol or a combination of these,
   wherein the amount of components (a)-(d) in the blowing agent is not less than about 95% by weight of all the blowing agents components in the formulation. For the purposes of convenience, blowing agents in accordance with this paragraph are referred to herein as Blowing Agent 1A3.

The present invention also includes blowing agent formulations for producing thermoplastic foams with excellent thermal insulating properties (including preferably low aged lambda (as defined hereinafter)) and low foam density, said blowing agent formulation comprising:
(a) from about 10% by weight to about 35% by weight of HCFO-1233zd(E);
(b) from about 40% by weight to about 65% by weight of HFC-134a;
(c) from about 10% to about 30% by weight of isobutane; and
(d) optionally up to about 15% by weight of dimethyl ether; and
(e) optionally up to about 10% by weight of or carbon dioxide or water or ethanol or a combination of these,
   wherein the amount of components (a)-(e) is not less than about 95% by weight of all the blowing agents components in the formulation. For the purposes of convenience, blowing agents in accordance with this paragraph are referred to herein as Blowing Agent 2A1.

The present invention also includes blowing agent formulations for producing thermoplastic foams with excellent thermal insulating properties (including preferably low aged lambda (as defined hereinafter)) and low foam density, said blowing agent formulation comprising:
(a) from about 10% by weight to about 28% by weight of HCFO-1233zd(E);
(b) from about 40% by weight to about 65% by weight of HFC-134a;
(c) from about 10% to about 30% by weight of isobutane; and
(d) optionally up to about 15% by weight of dimethyl ether; and
(e) optionally up to about 10% by weight of or carbon dioxide or water or ethanol or a combination of these,
   wherein the amount of components (a)-(e) is not less than about 95% by weight of all the blowing agents components in the formulation. For the purposes of convenience, blowing agents in accordance with this paragraph are referred to herein as Blowing Agent 2A2.

The present invention also includes blowing agent formulations for producing thermoplastic foams with excellent thermal insulating properties (including preferably low aged lambda (as defined hereinafter)) and low foam density, said blowing agent formulation comprising:
(a) from about 10% by weight to about 27% by weight of HCFO-1233zd(E);
(b) from about 40% by weight to about 65% by weight of HFC-134a;
(c) from about 10% to about 30% by weight of isobutane; and
(d) optionally up to about 15% by weight of dimethyl ether; and
(e) optionally up to about 10% by weight of carbon dioxide or water or ethanol or a combination of these,
   wherein the amount of components (a)-(e) is not less than about 95% by weight of all the blowing agents components in the formulation. For the purposes of convenience, blowing agents in accordance with this paragraph are referred to herein as Blowing Agent 2A3.

The present invention also includes blowing agent formulations for producing thermoplastic foams with excellent thermal insulating properties (including preferably low aged lambda (as defined hereinafter)) and low foam density, said blowing agent formulation comprising:
(a) from about 10% by weight to about 30% by weight of HCFO-1233zd(E);
(b) from about 40% by weight to about 65% by weight of HFC-134a;
(c) from about 10% to about 27% by weight of isobutane; and
(d) optionally up to about 15% by weight of dimethyl ether; and
(e) optionally up to about 10% by weight of carbon dioxide or water or ethanol or a combination of these,
   wherein the amount of components (a)-(e) is not less than about 95% by weight of all the blowing agents components in the formulation. For the purposes of convenience, blowing agents in accordance with this paragraph are referred to herein as Blowing Agent 2A3.

The present invention also includes blowing agent formulations for producing thermoplastic foams with excellent thermal insulating properties (including preferably low aged lambda (as defined hereinafter)) and low foam density, said blowing agent formulation comprising:
(a) from about 10% by weight to about 26% by weight of HCFO-1233zd(E);
(b) from about 40% by weight to about 65% by weight of HFC-134a;
(c) from about 10% to about 30% by weight of isobutane; and
(d) optionally up to about 15% by weight of dimethyl ether; and
(e) optionally up to about 10% by weight of carbon dioxide or water or ethanol or a combination of these,
   wherein the amount of components (a)-(e) is not less than about 95% by weight of all the blowing agents components in the formulation. For the purposes of convenience, blowing agents in accordance with this paragraph are referred to herein as Blowing Agent 2A4.

The present invention also includes blowing agent formulations for producing thermoplastic foams with excellent thermal insulating properties (including preferably low aged lambda (as defined hereinafter)) and low foam density, said blowing agent formulation comprising:
(a) from about 10% by weight to about 25% by weight of HCFO-1233zd(E);
(b) from about 40% by weight to about 65% by weight of HFC-134a;
(c) from about 10% to about 30% by weight of isobutane; and
(d) optionally up to about 15% by weight of dimethyl ether; and
(e) optionally up to about 10% by weight of carbon dioxide or water or ethanol or a combination of these,
   wherein the amount of components (a)-(e) is not less than about 95% by weight of all the blowing agents components in the formulation. For the purposes of convenience, blowing agents in accordance with this paragraph are referred to herein as Blowing Agent 2A5.

The present invention also comprises foamable thermoplastic compositions comprising:
(a) foamable thermoplastic polymer in a melt state; and
(b) a blowing agent formulation in said foamable thermoplastic polymer,
   wherein said blowing agent formulation is any one or more of Blowing Agents 1-2. For the purposes of convenience, blowing agents in accordance with this paragraph are referred to herein as Foamable Composition 1.

As used herein, reference to a defined blowing agent or a range of defined blowing agents, such as Blowing Agents 1-2, includes all blowing agents so defined, including any numbered blowing agent that includes a suffix. For example, reference to Blowing Agent 1 means that each of Blowing Agent 1A1, Blowing Agent 1A2, and Blowing Agent 1A3 are specifically included.

The present invention also comprises foamable thermoplastic compositions comprising:
(a) foamable polystyrene in a melt state; and
(b) a blowing agent formulation in said foamable thermoplastic polymer,
   wherein said blowing agent formulation is any one or more of Blowing Agents 1-2. For the purposes of convenience, blowing agents in accordance with this paragraph are referred to herein as Foamable Composition 2.

The present invention also includes methods of forming foam comprising:
(a) providing a foamable composition of the present invention, including Foamable Compositions 1 and 2; and
(b) foaming said foamable composition. For the purposes of convenience, methods in accordance with this paragraph are referred to herein as Foaming Method 1.

The present invention also includes methods of forming foam comprising:
(a) providing a foamable composition of the present invention, including Foamable Compositions 1 and 2; and
(b) foaming said foamable composition by a process that comprises extruding said foamable composition. For the purposes of convenience, methods in accordance with this paragraph are referred to herein as Foaming Method 2.

The present invention also includes thermoplastic foams comprising:
(a) a thermoplastic foam comprising a plurality of closed cells; and
(b) gaseous material contained in said closed cells, said gaseous material comprising a blowing agent of the present invention, including each of Blowing Agents 1-2. For the purposes of convenience, foams in accordance with this paragraph are referred to herein as Foam 1A.

The present invention also includes thermoplastic foams comprising:
(a) a thermoplastic foam comprising a plurality of closed polystyrene cells; and
(b) gaseous material contained in said closed cells, said gaseous material comprising a blowing agent of the present invention, including each of Blowing Agents 1-2. For the purposes of convenience, foams in accordance with this paragraph are referred to herein as Foam 1B.

The present invention also includes thermoplastic foams comprising:
(a) a thermoplastic foam comprising a plurality of closed cells; and
(b) gaseous material contained in said closed cells, said gaseous material comprising a blowing agent of the present invention, including each of Blowing Agents 1-2, wherein said foam has a density of not greater than 40 kg/m³ and an aged thermal conductivity of not greater than 29.5 mW/mK. For the purposes of convenience, foams in accordance with this paragraph are referred to herein as Foam 2A.

The present invention also includes thermoplastic foams comprising:
(a) a thermoplastic foam comprising a plurality of closed cells; and
(b) gaseous material contained in said closed cells, said gaseous material comprising a blowing agent of the present invention, including each of Blowing Agents 1-2, wherein said foam has a density of not greater than 39 kg/m³ and an aged thermal conductivity of not greater than 29.5 mW/mK. For the purposes of convenience, foams in accordance with this paragraph are referred to herein as Foam 2B.

The present invention also includes thermoplastic foams comprising:
(a) a thermoplastic foam comprising a plurality of closed cells; and
(b) gaseous material contained in said closed cells, said gaseous material comprising a blowing agent of the present invention, including each of Blowing Agents 1-2, wherein said foam has a density of not greater than 38 kg/m³ and an aged thermal conductivity of not greater than 29.5 mW/mK. For the purposes of convenience, foams in accordance with this paragraph are referred to herein as Foam 2C.

The present invention also includes thermoplastic foams comprising:
(a) a thermoplastic foam comprising a plurality of closed cells; and
(b) gaseous material contained in said closed cells, said gaseous material comprising a blowing agent of the present invention, including each of Blowing Agents 1-2, wherein said foam has a density of not greater than 37 kg/m³ and an aged thermal conductivity of not greater than 29.5 mW/mK. For the purposes of convenience, foams in accordance with this paragraph are referred to herein as Foam 2D.

The present invention also includes thermoplastic foams comprising:
(a) a thermoplastic foam comprising a plurality of closed cells; and
(b) gaseous material contained in said closed cells, said gaseous material comprising a blowing agent of the present invention, including each of Blowing Agents 1-2, wherein said foam has a density of not greater than 36 kg/m³ and an aged thermal conductivity of not greater than 29.5 mW/mK. For the purposes of convenience, foams in accordance with this paragraph are referred to herein as Foam 2E.

The present invention also includes thermoplastic foams comprising:
(a) a thermoplastic foam comprising a plurality of closed cells; and
(b) gaseous material contained in said closed cells, said gaseous material comprising a blowing agent of the present invention, including each of Blowing Agents 1-2, wherein said foam has a density of not greater than 35 kg/m³ and an aged thermal conductivity of not greater than 29.5 mW/mK. For the purposes of convenience, foams in accordance with this paragraph are referred to herein as Foam 2F.

The present invention also includes polystyrene foams comprising:
(a) a thermoplastic foam comprising a plurality of closed polystyrene cells; and
(b) gaseous material contained in said closed cells, said gaseous material comprising a blowing agent of the present invention, including each of Blowing Agents 1-2, wherein said foam has a density of not greater than 40 kg/m³ and an aged thermal conductivity of not greater than 29.5 mW/mK. For the purposes of convenience, foams in accordance with this paragraph are referred to herein as Foam 3A.

The present invention also includes polystyrene foams comprising:
(a) a thermoplastic foam comprising a plurality of closed polystyrene cells; and
(b) gaseous material contained in said closed cells, said gaseous material comprising a blowing agent of the present invention, including each of Blowing Agents 1-2, wherein said foam has a density of not greater than 39 kg/m³ and an aged thermal conductivity of not greater than 29.5 mW/mK. For the purposes of convenience, foams in accordance with this paragraph are referred to herein as Foam 3B.

The present invention also includes polystyrene foams comprising:
(a) a thermoplastic foam comprising a plurality of closed polystyrene cells; and
(b) gaseous material contained in said closed cells, said gaseous material comprising a blowing agent of the present invention, including each of Blowing Agents 1-2, wherein said foam has a density of not greater than 38 kg/m³ and an aged thermal conductivity of not greater than 29.5 mW/mK. For the purposes of convenience, foams in accordance with this paragraph are referred to herein as Foam 3C.

The present invention also includes polystyrene foams comprising:
(a) a thermoplastic foam comprising a plurality of closed polystyrene cells; and
(b) gaseous material contained in said closed cells, said gaseous material comprising a blowing agent of the present invention, including each of Blowing Agents 1-2, wherein said foam has a density of not greater than 37 kg/m³ and an aged thermal conductivity of not greater than 29.5 mW/mK. For the purposes of convenience, foams in accordance with this paragraph are referred to herein as Foam 3D.

The present invention also includes polystyrene foams comprising:
(a) a thermoplastic foam comprising a plurality of closed polystyrene cells; and
(b) gaseous material contained in said closed cells, said gaseous material comprising a blowing agent of the present invention, including each of Blowing Agents 1-2, wherein said foam has a density of not greater than 36 kg/m³ and an aged thermal conductivity of not greater than 29.5 mW/mK. For the purposes of convenience, foams in accordance with this paragraph are referred to herein as Foam 3E.

The present invention also includes polystyrene foams comprising:
(a) a thermoplastic foam comprising a plurality of closed polystyrene cells; and
(b) gaseous material contained in said closed cells, said gaseous material comprising a blowing agent of the present invention, including each of Blowing Agents 1-2, wherein said foam has a density of not greater than 35 kg/m³ and an aged thermal conductivity of not greater than 29.5 mW/mK. For the purposes of convenience, foams in accordance with this paragraph are referred to herein as Foam 3F.

### BRIEF DESCRIPTION OF THE DRAWING

FIG. 1 is a schematic representation of an extrusion system and process according to one embodiment of the invention and according to the examples herein.

FIG. 2 is a chart showing the results of the comparative examples and the examples of the present invention as described herein.

### DEFINITIONS

HFC-134a and 134a means 1,1,1,2-tetrafluoroethane.
Isobutane and iC4 and isoC4 each mean 2-methyl propane. 1233zd means 1-chloro-3,3,3-trifluoropropene, without limitation as to isomeric form.
trans1233zd and 1233zd(E) each means trans1-chloro-3,3,3-trifluoropropene.
cis1224 yd means cis1-chloro-2,3,3,3-tetrafluoropropane.
1234ze means 1,1,1,3-tetrafluoropropene, without limitation as to isomeric form.
Trans1234ze and 1234ze(E) each mean trans1,3,3,3-tetrafluoropropene.
Cis1336mzz and 1336mzz(Z) each mean cis-1,1,1,4,4,4-hexafluorobutene.
Trans1336mzz and 1336mzz(E) each mean trans1,1,1,4,4,4-hexafluorobutene.
Methyl formate means the following compound—

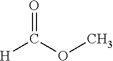

Methylal means dimethoxymethane ((CH3O)2CH2).
Dimethyl ether and DME each means the following compound—

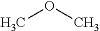

Isobutane and iC4 and isoC4 each mean 2-methyl propane.
Ethanol and EtOH each mean CH₃CH₂OH.
Closed cell foam means that a substantial volume percentage of the cells in the foam are closed, for example, about 20% by volume or more.
Styrene moiety means the compounds having the structure

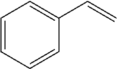

and all compounds in which one or more of the hydrogens are substituted.
Polystyrene, polystyrene resin, and PS each mean a polymer that is made from monomers that includes the styrene moiety, including homopolymers thereof, copolymers, and blends of polymers that include such homopolymers and/or copolymers.
XPS foam means polystyrene that has been formed into a foam in an extrusion process.
Aged thermal conductivity and aged lambda each means thermal conductivity measured as described in the examples.
Density means foam density as measured in the examples.
Blowing agent formulation refers to a component or combination of components that are used for and/or are intended to be used to foam a foamable material, including such combination of components that are introduced into the foamable material at a different time and/or place. Thus the term is intended to encompass the presence in an extrusion process of a first and a second blowing agent component in a foamable composition in cases in which the first blowing agent component is introduced into the foamable composition at first relatively upstream location in the extrusion process and the second component is introduced into the foamable composition at second, relatively downstream location in the extrusion process.

### DETAILED DESCRIPTION

### Blowing Agent

The blowing agent of the present invention, including each of Blowing Agents 1-2, may include one or more co-blowing agents other than those specified, provided they are of a type and amount that does not impair the ability of the blowing agent to be used to form the thermoplastic foam, preferably the polystyrene foam, and in particular XPS foam, and preferably do not prevent the foam from exhibiting one or more of the density and thermal conductivity properties described herein as aspects of the invention. Within this parameter, and by way of example only, the blowing agents of present, including each of Blowing Agents 1-2, may further include: (1) one or more of the following: saturated hydrocarbons having 3 to 5 carbon atoms such as propane, normal butane, and cyclopentane; (2) ethers such as ethyl ether, diethylether, and methyl ethyl ether; (3) alkyl chlorides such as methyl chloride and ethyl chloride; (4) alcohols such as methanol, propyl alcohol, isopropyl alcohol, butyl alcohol, sec-butyl alcohol, tert-butyl alcohol, aryl alcohol, crotyl alcohol, and propargyl alcohol; (5) ketones; (6) esters; and halogenated C1-C5 olefins, including 1234ze, 1224 yd and 1336mzz.

Other additives may also be included, again to the extent that the type and amount does not impair the ability of the blowing agent to be used to form polystyrene foam, and in particular XPS foam, having the density and thermal conductivity properties described herein as aspects of the invention. Within this parameter, and by way of example only, the blowing agents of present blowing agent of the present invention, including each of Blowing Agents 1-2, may include one or more of the following: processing aids, flame retardants, coloring agents, stabilizers, surfactants, polymer modifiers, toughening agents, colorants, dyes, solubility enhancers, rheology modifiers, plasticizing agents, flammability suppressants, antimicrobial agents, viscosity reduction modifiers, fillers, vapor pressure modifiers, nucleating agents, catalysts and the like.

### Foamable Compositions

The present invention includes also foamable thermoplastic compositions comprising a thermoplastic polymer and blowing agent in the thermoplastic polymer. The present invention includes foamable compositions, including foamable polystyrene compositions, comprising the Blowing Agent (using the Blowing Agent numbers as defined above) as identified in the following Foamable Composition Table:

FOAMABLE COMPOSITION TABLE

| Foamable | Particular | Foam | Amount of Blowing |
|---|---|---|---|
| Composition | Thermoplastic | Blowing | Agent in Foamable |
| (FC) No. | Material | Agent | Composition, pph |
| FC-3A | NR | 1 | NR |
| FC-3B | NR | 2 | NR |
| FC-4A | comprises | 1 | NR |
| | polystyrene | | |
| FC-4B | comprises | 2 | NF |
| | polystyrene | | |
| FC-5A | consists | 1 | NR |
| | essentially of | | |
| | polystyrene | | |
| FC-5B | consists | 2 | NR |
| | essentially of | | |
| | polystyrene | | |
| FC-8A | NR | 1 | 6-12 |
| FC-8B | NR | 2 | 6-12 |
| FC-9A | comprises | 1 | 6-12 |
| | polystyrene | | |
| FC-9B | comprises | 2 | 6-12 |
| | polystyrene | | |
| FC-10A | consists | 1 | 6-12 |
| | essentially of | | |
| | polystyrene | | |
| FC-10B | consists | 2 | 6-12 |
| | essentially of | | |
| | polystyrene | | |
| FC-11A | NR | 1 | 7-10 |
| FC-11B | NR | 2 | 7-10 |
| FC-12A | comprises | 1 | 7-10 |
| | polystyrene | | |
| FC-12B | comprises | 2 | 7-10 |
| | polystyrene | | |
| FC-13A | consists | 1 | 7-10 |
| | essentially of | | |
| | polystyrene | | |
| FC-13B | consists | 2 | 7-10 |
| | essentially of | | |
| | polystyrene | | |
| FC-14A | NR | 1 | 7-10 |
| FC-14B | NR | 2 | 7-10 |
| FC-15A | comprises | 1 | 7-9 |
| | polystyrene | | |
| FC-15B | comprises | 2 | 7-9 |
| | polystyrene | | |
| FC-16A | consists | 1 | 7-9 |
| | essentially of | | |
| | polystyrene | | |
| FC-16B | consists | 2 | 7-9 |
| | essentially of | | |
| | polystyrene | | |

The styrene resin for use in the present invention, including each of the foamable compositions identified above and in the Foamable Composition Table above, or the foams identified above or in the XPS Foam Table below, is not particularly limited and examples of the styrene resin include homopolymers of styrene monomers such as styrene, methylstyrene, ethylstyrene, isopropylstyrene, dimethylstyrene, bromostyrene, chlorostyrene, vinyltoluene, and vinylxylene, or copolymers of two or more of the monomers, copolymers obtained by copolymerization of the styrene monomer with at least one or two or more of monomers such as divinylbenzene, butadiene, acrylic acid, methacrylic acid, methyl acrylate, methyl methacrylate, acrylonitrile, maleic anhydride, and itaconic anhydride, and the like. The monomers to be copolymerized with the styrene monomer, such as acrylic acid, methacrylic acid, methyl acrylate, methyl methacrylate, maleic anhydride, and itaconic anhydride, can be used with such an amount that the physical properties, such as compressive strength, of the extruded polystyrene foam to be produced are not impaired. The styrene resin for use in the present invention is not limited to the homopolymers or the copolymers of the styrene monomers and may be a blend of the homopolymers or the copolymers of the styrene monomers and the homopolymers or the copolymers of the other monomers, and a diene rubber reinforced polystyrene or an acrylic rubber reinforced polystyrene can be blended. The styrene resin for use in the present invention may be a styrene resin having a branched structure for the purpose of adjusting the melt volume rate (hereinafter also referred to as MVR), a melt viscosity and a melt tension in molding, and the like.

According to preferred embodiments, the styrene resin for use in the present invention, including each of the foamable compositions identified above and in the Foamable Composition Table above, or the foams identified above or in the XPS Foam Table below, are formed from a general purpose styrene resin, preferably having an MVR of 0.1 to 50 g/10 minutes. Such resins are preferably used in the respect that a thermoplastic resin foam in which the moldability in extrusion foam molding is excellent, the discharge amount in molding, the thickness and the width and the apparent density or the closed cell ratio of the obtained extruded polystyrene foam can be adjusted to desired values. The MVR of the styrene resin can include from 0.3 to 30 g/10 minutes, or 0.5 to 25 g/10. In the present invention, the MVR is measured by ISO 1133.

In the present invention, among the styrene resin mentioned above, polystyrene resin is suitable in the respect of economical efficiency and processability. When higher heat resistance is required in an extruded foam, it is preferable to use a styrene-acrylonitrile copolymer, (meth)acrylic acid-copolymerized polystyrene, maleic anhydride-modified polystyrene. When a higher impact resistance is demanded in an extruded foam, it is preferable to use rubber-reinforced polystyrene. The styrene resin may be used alone or two or more kinds of styrene resin different in a copolymerization component, a molecular weight and a molecular weight distribution, a branched structure, an MVR, and the like may be used as a mixture.

The PS used to form the present foams, including the foams identified in the XPS FOAM TABLE above and in each of each of Foams 1-3, and which is used in accordance with the present methods, including each of Methods 1-2, can have properties within each of the broad, intermediate and narrow ranges identified in the following table:

| Polymer | Broad | Intermediate | Narrow |
|---|---|---|---|
| property, | Range | Range | Range |
| Melt Volume | 0.1-50 | 10-40 | 15-30 |
| Rate, ISO 1133 | | | |
| (cm3/10 min.) | | | |
| Vicat Softening | 90-115 | 95-110 | 95-105 |
| Temperature | | | |
| VST/B/50 (50N, | | | |
| 50° C./h) | | | |
| Melting | 100-350 | 150-300 | 180-280 |
| Temperature, | | | |
| Tm, ° C. | | | |

### Foams

The present invention includes also thermoplastic foam, including and preferably PS foam and even more preferably XPS foam, wherein the thermoplastic comprises polystyrene, and a blowing agent of the present invention, including each of Blowing Agents 1-2.

The present invention preferably includes XPS foam comprising:
(a) thermoplastic polymer cells comprising cell walls forming closed cells, wherein in the cell walls comprise polystyrene; and
(b) Blowing Agent 1 contained in the closed cells. For the purposes of convenience, foams in accordance with this paragraph are referred to herein as XPS Foam 1.

The present invention includes XPS foam comprising:
(a) thermoplastic polymer cells comprising cell walls forming closed cells, wherein in the cell walls comprise polystyrene; and
(b) Blowing Agent 2 contained in the closed cells. For the purposes of convenience, foams in accordance with this paragraph are referred to herein as XPS Foam 2.

### Methods

Applicants have found that unexpected advantages can be achieved with respect to the preparation of thermoplastic foams, including each of Foam 1-Foam 3, by using a blowing agent of the present invention, including each of Blowing Agent 1-Blowing Agent 2, in the foam forming process.

In particular aspects, the present invention includes method for making thermoplastic XPS foam comprising:
(i) providing PS; and
(ii) foaming the PS using any one of the blowing agents of the present invention, including each of Blowing Agent 1 through Blowing Agent 2. For the purposes of convenience, methods in accordance with this paragraph are referred to herein as Foaming Method 3.

The present invention also provides methods for forming extruded thermoplastic foam comprising:
(i) providing a thermoplastic material;
(ii) extruding the thermoplastic material; and
(iii) foaming the thermoplastic material using any one of the blowing agents of the present invention, including each of Blowing Agent 1 through Blowing Agent 2. For the purposes of convenience, methods in accordance with this paragraph are referred to herein as Foaming Method 4.

The present invention also provides methods for forming XPS comprising:
(i) providing a thermoplastic polystyrene;
(ii) extruding the thermoplastic polystyrene; and
(iii) foaming a polystyrene foam using any one of the blowing agents of the present invention, including each of Blowing Agent 1 through Blowing Agent 2. For the purposes of convenience, methods in accordance with this paragraph are referred to herein as Foaming Method 5.

The present invention also provides methods for making XPS foams comprising:
(i) providing PS; and
(ii) foaming the PS using any one of the blowing agents of the present invention, including each of Blowing Agent 1 through Blowing Agent 2, wherein the foam has a density of about 37 kg/m3 or less and an aged thermal conductivity of 30 mW/mk or less. For the purposes of convenience, methods in accordance with this paragraph are referred to herein as Foaming Method 6A.

The present invention also provides methods for forming extruded thermoplastic foam comprising:
(i) providing PS;
(ii) extruding PS; and
(iii) foaming the PS using any one of the blowing agents of the present invention, including each of Blowing Agent 1 through Blowing Agent 2, wherein the foam has a density of about 37 kg/m3 or less and an aged thermal conductivity of 29.5 mW/mK or less. For the purposes of convenience, methods in accordance with this paragraph are referred to herein as Foaming Method 6B.

The present invention also provides methods for forming extruded thermoplastic foam comprising:
(i) providing PS;
(ii) extruding PS; and
(iii) foaming the PS using any one of the blowing agents of the present invention, including each of Blowing Agent 1 through Blowing Agent 4, wherein the foam has a density of about 37 kg/m3 or less and an aged thermal conductivity of 29 mW/mK or less. For the purposes of convenience, methods in accordance with this paragraph are referred to herein as Foaming Method 6C.

The present invention also provides methods for making thermoplastic foams, including each of Method 1 through Method 6 wherein said blowing agent is used in an amount of from about 6 parts per hundred of thermoplastic resin material (hereinafter “pph” or “pphr”) to about 12 pphr. For the purposes of convenience, methods in accordance with this paragraph are referred to herein as Method 7.

The present invention also provides methods for making thermoplastic foams, including each of Method 1 through Method 4, wherein said blowing agent is used in an amount of from about 6 pph to about 10 pphr. For the purposes of convenience, methods in accordance with this paragraph are referred to herein as Method 8.

The present invention also provides methods for making thermoplastic foams, including each of Method 1 through Method 4, wherein said blowing agent is used in an amount of from about 7 pph to about 9 pph. For the purposes of convenience, methods in accordance with this paragraph are referred to herein as Method 9.

The present invention also provides methods for making thermoplastic foams, including each of Method 1 through Method 9, wherein said step of providing said thermoplastic material or PS comprises including in said thermoplastic material one or more optional components selected from surfactants, polymer modifiers, toughening agents, colorants, dyes, solubility enhancers, rheology modifiers, plasticizing agents, flammability suppressants, antimicrobial agents, viscosity reduction modifiers, fillers, vapor pressure modifiers, nucleating agents, catalysts and the like. For the purposes of convenience, methods in accordance with this paragraph are referred to herein as Method 10.

The present invention also provides methods for forming extruded thermoplastic foam comprising:
(i) providing a melt comprising, or consisting essentially of, polystyrene and a blowing agent, including each of Blowing Agents 1-2, wherein the amount of said blowing agent is present in the melt in an amount of from about 6 pph to less than 12 pph;
(ii) extruding the melt; and
(iii) foaming the melt to form an extruded polystyrene foam having a density of from about 25 kg/m³ to less than about 37 kg/m³ and an aged thermal conductivity of less than about 30 mW/mk. For the purposes of convenience, methods in accordance with this paragraph are referred to herein as Method 11A.

The present invention also provides methods for forming extruded thermoplastic foam comprising:
(i) providing a melt comprising, or consisting essentially of, polystyrene and a blowing agent, including each of Blowing Agents 1-4, wherein the amount of said blowing agent is present in the melt in an amount of from about 6 pph to less than 10 pph;
(ii) extruding the melt; and
(iii) foaming the melt to form an extruded polystyrene foam having a density of less than about 36 kg/m³ and an aged thermal conductivity of about 30 mW/mK or less. For the purposes of convenience, methods in accordance with this paragraph are referred to herein as Method 11B.

The present invention also provides methods for forming extruded thermoplastic foam comprising:
(i) providing a melt comprising, or consisting essentially of, polystyrene and a blowing agent, including each of Blowing Agents 1-2, wherein the amount of said blowing agent is present in the melt in an amount of from about 6 pph to less than 10 pph;
(ii) extruding the melt; and
(iii) foaming the melt to form an extruded polystyrene foam having a density of from about 25 kg/m³ to less than 35.5 kg/m³ and an aged thermal conductivity of from about 25 mW/mK to less than 30 mW/mK or less. For the purposes of convenience, methods in accordance with this paragraph are referred to herein as Method 11C.

The present invention also provides methods for forming extruded thermoplastic foam comprising:
(i) providing a melt comprising, or consisting essentially of, polystyrene and a blowing agent, including each of Blowing Agents 1-2, wherein the amount of said blowing agent is present in the melt in an amount of from about 7 pph to less than 10 pph;
(ii) extruding the melt; and
(iii) foaming the melt to form an extruded polystyrene foam having a density of from about 25 kg/m³ to less than about 35.5 kg/m³ and an aged thermal conductivity of from about 25 mW/mK to less than 29.5 mW/mK. For the purposes of convenience, methods in accordance with this paragraph are referred to herein as Method 11D.

The present invention also provides methods for forming extruded thermoplastic foam comprising:
(i) providing a melt comprising, or consisting essentially of, polystyrene and a blowing agent, including each of Blowing Agents 1-2, wherein the amount of said blowing agent is present in the melt in an amount of from about 6 pph to less than 10 pph;
(ii) extruding the melt; and
(iii) foaming the melt to form an extruded polystyrene foam having a density of from about 25 kg/m³ to less than 36 kg/m³ and an aged thermal conductivity of from about 25 mW/mK to less than about 28.5 mW/mK. For the purposes of convenience, methods in accordance with this paragraph are referred to herein as Method 11E.

The present invention also provides methods for forming extruded thermoplastic foam comprising:
(i) providing a melt comprising, or consisting essentially of, polystyrene and a blowing agent, including each of Blowing Agents 1-2, wherein the amount of said blowing agent is present in the melt in an amount of from about 6 pph to less than 10 pph;
(ii) extruding the melt; and
(iii) foaming the melt to form an extruded polystyrene foam having a density of from about 25 kg/m³ to less than 35.5 kg/m³ and an aged thermal conductivity of from about 25 mW/mK to less than 29.5 mW/mK. For the purposes of convenience, methods in accordance with this paragraph are referred to herein as Method 11F.

The present invention also provides methods for forming extruded thermoplastic foam comprising:
(i) providing a melt comprising, or consisting essentially of, polystyrene and a blowing agent, including each of Blowing Agents 1-2, wherein the amount of said blowing agent is present in the melt in an amount of from about 6 pph to less than 10 pph;
(ii) extruding the melt; and
(iii) foaming the melt to form an extruded polystyrene foam having a density of from about 25 kg/m³ to less than 35.5 kg/m³ and an aged thermal conductivity of from about 25 mW/mK to less than 29 mW/mK. For the purposes of convenience, methods in accordance with this paragraph are referred to herein as Method 11G.

The methods of the present invention, including each of Methods 1-11, can be formed from any PS resin, including general purpose styrene resin, preferably having an MVR of 0.1 to 50 g/10 minutes, more preferably of from 11 to 40 g/10 minutes, more preferably from 10 to 30 g/10 minutes.

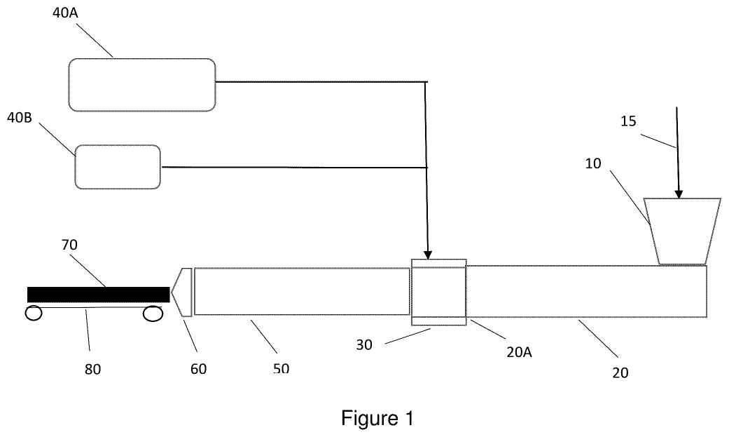

The methods can be carried out, by way of example, using extrusion equipment of the general type disclosed in FIG. 1, which is described below in more detail below in connection with the examples. It will be appreciated that while FIG. 1 shows only a single feed point for introducing blowing agent into the extrusion process, the use of multiple feed points to introduce the blowing agent may be used. Furthermore, it will be appreciated that the term “blowing agent” as used herein, including each of Blowing Agents 1-2, includes not only the defined set of components introduced into the extruder when there is a single introduction point, but also the aggregate combination of components that may be introduced at plural points into the extrusion or other foaming equipment.

### Examples

The following examples are provided for the purpose of illustrating the present invention but without limiting the scope thereof.

The examples utilized an extrusion apparatus substantially as illustrated in FIG. 1. In particular, the apparatus included a raw material feed hopper 10 for holding polystyrene feed material 15, together with any optional components (which may be added with the polystyrene or optionally elsewhere in the process depending on the particular needs of the user). In the case of the examples hereof, the polystyrene feed is in the form of general purpose polystyrene pellets sold by Ineos under the trade designation Styrolution 156F and having the following properties:

| Property, | | | |
|---|---|---|---|
| Test Condition | Standard | Unit | Values |
| Melt Volume | ISO 1133 | cm³/10 min | 28 |
| Rate, 200° C./5 | | | |
| kg | | | |
| Vicat Softening | ISO 306 | ° C. | 101 |
| Temperature | | | |
| VST/B/50 (50N, | | | |
| 50° C./h) | | | |
| Melt | ISO 294 | ° C. | 180-280 |
| Temperature | | | |
| Range | | | |

The feed material also included the flame retardant sold under the trade designation Apryos 5PB12HT, the nucleating agent (GRANIC 2281) and processing aid (Zinc Stearate). The total of the raw material feed stream 15 used to form the foam and introduced into the single screw extruder 20 are based on the following concentrations of components:

| Component | pph |
|---|---|
| polystyrene (Styrolution 156F) | 100 |
| Copolymer (Low density | 0.3 |
| polyethylene - PE 003 from | |
| Repsol) | |
| flame retardants (Apyros | 2 |
| 5PB12HT) | |
| nucleating agent (GRANIC | 0.8 |
| 2281 - talc) | |
| processing aid (Zinc Stearate) | 0.8 |
| Blowing agent (total of all co- | 5.2-9 |
| blowing agents) | |

The feed materials 15, excluding the blowing agent, were charged to the hopper and delivered to the screw extruder 10 at a nominal rate of about 3.3 kilograms per hour and the screw operated with at a nominal 85 rpm. The extruder 20 had thermocouples (not shown) located at three points along the length thereof and a pressure sensor (not shown) at the discharge end 20A of the extruder. A mixer section 30 was located at the discharge end 20A of the extruder for receiving blowing agent components via one or more metering pumps 40A and 40B and mixing those blowing agents into the polystyrene melt in the mixer section. Sensors (not shown) were included for monitoring the temperature and pressure of the mixer section 30. The mixer section 30 discharged the melt with the blowing agent into a pair of melt coolers 50 oriented in series, with temperature sensors (not shown) located in each cooler to monitor the melt temperature. The melt was then extruded through a die 60 which also had temperature and pressure sensors (not shown) for monitoring the pressure and temperature at the die. The die pressure was varied from 70 to 100 bars to minimize the density for each blowing agent tested and the die temperature was kept at 128° C. Exiting the die was a foamed sheet of polystyrene 70 which is carried away from the extrusion equipment by a conveyor belt 80.

The equipment illustrated in FIG. 1 and described above was used for each of the experimental tests described in the examples below to form a foam. After the foam is formed, the density and aged thermal conductivity (also referred to as “aged lambda”) were measured. The aged lambda values were measured according to ISO 11561:199 (providing similar results as European Standard BS EN 13164:2012+A1:2015), modified in accordance with the description proved below:
Day 0—the foam is extruded
Day 1—initial thermal conductivity of the block (skins, 120×120 mm, thickness of 15-20 mm) is determined at 10° C.+/−2° C.
Day 4-slicing of the block into 6 mm thick slices is performed (with skins removed) to obtain one slice per extruded sample that is 23 mm wide and 120 mm long and then at least 4 slices are stacked; thermal conductivity of the stack is measured at 10° C.+/−2° C. and then the slices are separated and kept at about 23° C. and 50% relative humidity.
Days 6-36—the procedure of Day 4 is repeated every two or three days until about 28 days is reached to obtain aged thermal conductivity by Method A, which comprises plotting the lambda values against time and then calculating aged thermal conductivity (\aged).

Delta Lambda is the difference between the aged lambda and the initial lambda.

### Comparative Examples C1-C44-XPS Foam

In Comparative Examples C1-C44, extruded polystyrene foams were produced using the equipment and materials described above and illustrated in FIG. 1. All of the foams were prepared using the same raw materials except a different blowing agent was used in each case, as indicated in Table C1-C44 below. In each case, the die pressure which minimized the foam density was determined and used to produce the foam.

After the foam was formed, the density, the initial thermal conductivity, aged thermal conductivity (also referred to as “aged lambda”) were measured (unless indicated in Table C1-C44 with the designation ND, in which case the value was not determined) in accordance with the descriptions above. The results are reported in Table C1-C44 below (with pph being the parts by weight per hundred parts of polystyrene).

TABLE C1-C44

| | | | | | | | | | | | Foam Properties | | | |
|---|---|---|---|---|---|---|---|---|---|---|---|---|---|---|
| | Tot. | Blowing Agent Components, | | | | | | | | | | Thermal Conductivity, | | |
| | BA, | wt % in Blowing Agent Formulation | | | | | | | | | Density, | mW/mK | | |
| Ex. | pph | 134a | 1233zd | CO2 | DME | EtOh | iC4 | MF | 152a | H2O | Kg/m³ | Initial | Aged | Delta |
| C1 | 9.5 | 42.1 | 15.8 | 0.0 | 0.0 | 42.1 | 0.0 | 0.0 | 0.0 | 0.0 | 31.9 | 26.38 | 32.65 | 6.27 |
| C2 | 8.5 | 41.2 | 17.7 | 0.0 | 41.2 | 0.0 | 0.0 | 0.0 | 0.0 | 0.0 | 32.5 | 25.18 | 31.61 | 6.43 |
| C3 | 9 | 33.3 | 22.2 | 0.0 | 0.0 | 0.0 | 0.0 | 0.0 | 44.4 | 0.0 | 32.6 | 22.62 | 31.15 | 8.53 |
| C4 | 9 | 26.3 | 27.8 | 0.0 | 0.0 | 0.0 | 0.0 | 0.0 | 44.4 | 0.0 | 33.1 | 22.24 | 31.38 | 9.14 |
| C5 | 8 | 43.8 | 12.5 | 0.0 | 43.8 | 0.0 | 0.0 | 0.0 | 0.0 | 0.0 | 33.2 | 25.13 | 31.17 | 6.04 |
| C6 | 8 | 50.0 | 12.5 | 0.0 | 37.5 | 0.0 | 0.0 | 0.0 | 0.0 | 0.0 | 33.8 | 23.61 | 30.81 | 7.2 |
| C7 | 9.5 | 47.4 | 26.3 | 0.0 | 0.0 | 26.3 | 0.0 | 0.0 | 0.0 | 0.0 | 33.8 | 23.7 | 31.11 | 7.41 |
| C8 | 9.5 | 42.1 | 21.1 | 0.0 | 0.0 | 36.8 | 0.0 | 0.0 | 0.0 | 0.0 | 34 | 25.18 | 31.93 | 6.75 |
| C9 | 9 | 38.9 | 22.2 | 0.0 | 0.0 | 38.9 | 0.0 | 0.0 | 0.0 | 0.0 | 34.8 | 24.65 | 31.12 | 6.47 |
| C10 | 8.7 | 40.2 | 34.5 | 0.0 | 11.5 | 0.0 | 13.8 | 0.0 | 0.0 | 0.0 | 35.4 | 24.05 | 31.5 | 7.45 |
| C11 | 9 | 38.9 | 22.2 | 0.0 | 0.0 | 0.0 | 0.0 | 0.0 | 38.9 | 0.0 | 35.6 | 22.7 | 31.67 | 8.97 |
| C12 | 9 | 44.4 | 22.2 | 0.0 | 0.0 | 33.3 | 0.0 | 0.0 | 0.0 | 0.0 | 35.9 | 24.67 | 31.53 | 6.86 |
| C13 | 8 | 50 | 18.8 | 0.0 | 31.3 | 0.0 | 0.0 | 0.0 | 0.0 | 0.0 | 36.2 | 23.45 | 30.71 | 7.26 |
| C14 | 10 | 45.0 | 45.0 | 10.0 | 0.0 | 0.0 | 0.0 | 0.0 | 0.0 | 0.0 | 40.6 | 21.53 | 29.11 | 7.58 |
| C15 | 8.7 | 51.7 | 28.7 | 19.5 | 0.0 | 0.0 | 0.0 | 0.0 | 0.0 | 0.0 | 41.3 | 24.51 | 32.32 | 7.81 |
| C16 | 9 | 50.0 | 38.9 | 11.1 | 0.0 | 0.0 | 0.0 | 0.0 | 0.0 | 0.0 | 42.9 | 22.8 | 30.62 | 7.82 |
| C17 | 8.5 | 58.8 | 29.4 | 11.8 | 0.0 | 0.0 | 0.0 | 0.0 | 0.0 | 0.0 | 42.9 | 22.44 | 28.21 | 5.77 |
| C18 | 11 | 75 | 25 | 0.0 | 0.0 | 0.0 | 0.0 | 0.0 | 0.0 | 0.0 | 41 | 27.59 | 31.17 | 3.58 |
| C19 | 10 | 75 | 25 | 0.0 | 0.0 | 0.0 | 0.0 | 0.0 | 0.0 | 0.0 | 47.6 | 23.68 | 31.67 | 7.99 |
| C20 | 9.51 | 74.97 | 25.03 | 0.0 | 0.0 | 0.0 | 0.0 | 0.0 | 0.0 | 0.0 | 53.2 | 24.32 | 32.58 | 8.26 |
| C21 | 8.96 | 78.79 | 21.21 | 0.0 | 0.0 | 0.0 | 0.0 | 0.0 | 0.0 | 0.0 | 51.6 | 22.78 | 32.23 | 9.45 |
| C22 | 9.51 | 84.96 | 15.04 | 0.0 | 0.0 | 0.0 | 0.0 | 0.0 | 0.0 | 0.0 | 54.2 | 21.81 | 29.08 | 7.27 |
| C23 | 9 | 75.56 | 18.89 | 5.56 | 0.0 | 0.0 | 0.0 | 0.0 | 0.0 | 0.0 | 52.3 | 26.16 | 32.87 | 6.71 |
| C24 | 9 | 71.11 | 17.78 | 0.0 | 0.0 | 0.0 | 0.0 | 0.0 | 11.11 | 0.0 | 44.7 | 24.05 | 31.28 | 7.23 |
| C25 | 9 | 73.33 | 18.33 | 0.0 | 0.0 | 0.0 | 0.0 | 0.0 | 8.33 | 0.0 | 48.7 | 21.61 | 31.35 | 9.74 |
| C26 | 9.5 | 80.53 | 8.95 | 0.0 | 0.0 | 0.0 | 0.0 | 0.0 | 10.53 | 0.0 | 48.5 | 21.38 | 28.54 | 7.16 |
| C27 | 9.5 | 75.79 | 18.95 | 0.0 | 0.0 | 0.0 | 5.26 | 0.0 | 0.0 | 0.0 | 42.1 | 26.27 | 31.41 | 5.14 |
| C28 | 9.5 | 67.37 | 16.84 | 0.0 | 0.0 | 0.0 | 15.79 | 0.0 | 0.0 | 0.0 | 45.6 | 24.46 | 31.06 | 6.6 |
| C29 | 9.5 | 80.53 | 8.95 | 0.0 | 0.0 | 0.0 | 10.53 | 0.0 | 0.0 | 0.0 | 46.7 | 22.56 | 28.78 | 6.22 |
| C30 | 10 | 60.00 | 15.00 | 0.0 | 0.0 | 0.0 | 25 | 0.0 | 0.0 | 0.0 | 48 | 22.68 | 28.6 | 5.92 |
| C31 | 11.5 | 60.00 | 40.00 | 0.0 | 0.0 | 0.0 | 0.0 | 0.0 | 0.0 | 0.0 | 50.2 | ND | 28.34 | — |
| C32 | 11. | 75.00 | 25.00 | 0.0 | 0.0 | 0.0 | 0.0 | 0.0 | 0.0 | 0.0 | 51.5 | ND | 28.62 | — |
| C33 | 9.5 | 75.79 | 8.42 | 5.26 | 0.0 | 0.0 | 10.53 | 0.0 | 0.0 | 0.0 | 47.3 | ND | 27.5 | — |
| C34 | 9.5 | 71.58 | 12.63 | 5.26 | 0.0 | 0.0 | 10.53 | 0.0 | 0.0 | 0.0 | 50 | ND | 28.33 | — |
| C35 | 9. | 75.56 | 18.89 | 0.0 | 0.0 | 0.0 | 0.0 | 0.0 | 0.0 | 5.56 | 44.9 | ND | 28.23 | — |
| C36 | 9 | 85.00 | 9.44 | 0.0 | 0.0 | 0.0 | 0.0 | 0.0 | 0.0 | 5.56 | 47.4 | ND | 28.42 | — |
| C37 | 9 | 80.00 | 8.89 | 0.0 | 0.0 | 0.0 | 0.0 | 0.0 | 0.0 | 11.11 | 46.2 | ND | 28.71 | — |
| C38 | 9.5 | 75.79 | 18.95 | 0.0 | 5.26 | 0.0 | 0.0 | 0.0 | 0.0 | 0.0 | 46.3 | ND | 29.7 | — |
| C39 | 9.5 | 71.58 | 12.63 | 0.0 | 5.26 | 0.0 | 10.53 | 0.0 | 0.0 | 0.0 | 46.4 | ND | 28.03 | — |
| C40 | 9.5 | 75.79 | 8.42 | 0.0 | 5.26 | 0.0 | 10.53 | 0.0 | 0.0 | 0.0 | 46.3 | ND | 28.94 | — |
| C41 | 8.5 | 70.59 | 17.65 | 0.0 | 0.0 | 0.0 | 11.76 | 0.0 | 0.0 | 0.0 | 45.3 | ND | 28.41 | — |
| C42 | 8.5 | 63.53 | 7.06 | 5.88 | | | 23.53 | | | | 41.2 | ND | 28.34 | — |
| C43 | 8.5 | 63.53 | 7.06 | | 5.88 | | 23.53 | | | | 42.9 | ND | 27.85 | — |
| C44 | 8.5 | 56.47 | 14.12 | | 5.88 | | 23.53 | | | | 42.9 | ND | 27.1 | — |

As can be seen from Table C1-C44 above, the tests used 44 different combinations of co-blowing agents, with the combinations being based on two or more of the following:
HFC-134a (134a)
1233zd(E) (1233zd)
Carbon Dioxide (CO2)
Dimethyl ether (DME)
Ethanol (EtOH)
Isobutane (iC4)
Methyl formate (MF)
HFC-152a (152a)
Water (H2O)
   The results of this experimental work show, in general, that despite attempting 44 different combinations of the above-noted components, it was not possible to achieve an extruded polystyrene foam from these components in the indicated amounts that was able to achieve a foam density less than 40 kg/m³, and even more preferably less than 39 kg/m³, and even more preferably less than 37 kg/m³, and at the same time an Aged Lambda less than 29.5 mW/mk.

While several of these 44 foams achieved the desired density, and while several of the foams achieved the desired aged lambda, not one of these experiments was able to achieve both of these highly desirable properties.

### Examples 1-12—XPS Foam from Blowing Agent Containing 134a, 1233zd(E) and Isobutane

A series of foam extrusion runs were conducted using the same equipment, the same operating criteria, and the same raw materials as described above in connection with the Comparative Examples, except that the blowing agents as identified in Table E1-E12 below were used and produced a foam having the properties as reported in Table E1-E12 below:

TABLE E1-E12

| | PPHR, | | | | | | | Thermal Conductivity, | | |
|---|---|---|---|---|---|---|---|---|---|---|
| Ex. | BA in | Wt % in Blowing Agent | | | | | Density | mW/mK | | |
| No. | melt | 134a | 1233zd | iC4 | DME | CO2 | (kg/m3) | Initial | Aged | Delta |
| E1 | 8.5 | 41.2 | 35.3 | 23.5 | 0 | 0 | 34.4 | 22.05 | 27.61 | 5.56 |
| E2 | 7.8 | 44.9 | 32.1 | 23.1 | 0 | 0 | 35.4 | 21.93 | 27.44 | 5.51 |
| E3 | 8.3 | 42.2 | 36.1 | 21.7 | 0 | 0 | 35.4 | 21.92 | 27.48 | 5.56 |
| E4 | 8.4 | 38.1 | 38.1 | 14.3 | 9.52 | 0 | 35.7 | 22.91 | 28.44 | 5.53 |
| E5 | 8.5 | 41.2 | 41.2 | 17.7 | 0 | 0 | 35.8 | 22.99 | 28.54 | 5.55 |
| E6 | 8.5 | 41.2 | 35.3 | 17.7 | 5.9 | 0 | 34.9 | 22.98 | 29.0 | 6.02 |
| E7 | 7.8 | 44.9 | 32.1 | 23.8 | 0 | 0 | 34.8 | 22.43 | 28.94 | 6.51 |
| E8 | 8.5 | 47.1 | 35.3 | 17.7 | 0 | 0 | 37 | 23.95 | 29.07 | 6.02 |
| E9 | 8.1 | 37.0 | 43.2 | 14.8 | 0 | 4.9 | 37.7 | 23.21 | 28.56 | 5.35 |
| E10 | 8.1 | 30.9 | 49.4 | 14.8 | 0 | 4.9 | 39.7 | 24.65 | 28.61 | 3.96 |
| E11 | 8.5 | 58.82 | 17.65 | 23.53 | 0 | 0 | 39.3 | ND | 27.91 | — |
| E12 | 8.5 | 56.47 | 14.12 | 23.53 | 0 | 5.88 | 39.8 | ND | 28.51 | — |

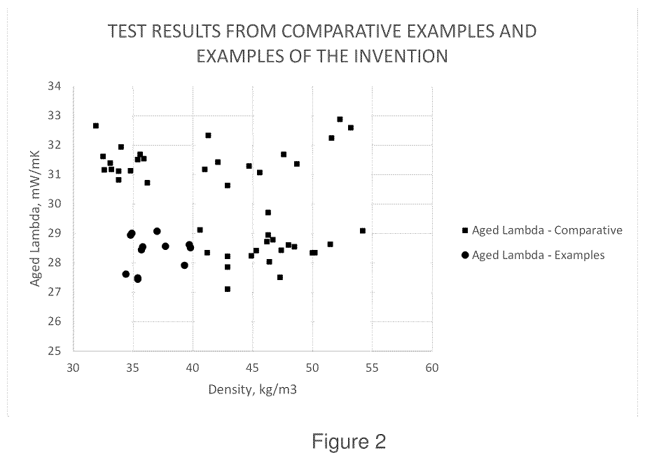

As can be seen from Table E1-E12, applicants have unexpectedly found that certain blowing agents can be formulated based on a combination of HFC-134a, 1233zd(E) and isobutane, both without and with DME or CO2, which are able to achieve thermoplastic foams having density and aged lambda values within the preferred requirements outlined herein. This is illustrated in FIG. 2, which is a chart which shows the results of the Comparative Examples 1˜4 and the foams of these Examples E1-E12 on a plot of density versus aged lambda. As illustrated in FIG. 2, the present invention in preferred embodiments is able to achieve extruded polystyrene foam which at once has a density of 40 kg/m³ and even more preferably less than 39 kg/m³, and even more preferably less than 37 kg/m³, or less, and at the same time a thermal conductivity of 29.5 or less. The other 44 comparative test results were not able to achieve a foam with this highly desirable combination of important properties. This is an unexpected result.

### Examples 13-32—XPS Foam from Blowing Agent Containing 134a, 1233zd(E), and Isobutane

A series of foam extrusion runs are conducted using the same equipment, the same operating criteria, and the same raw materials as described above in connection with the Comparative Examples, except that the blowing agents as identified in Table E13-E32 below are used to produce a foam having the properties as reported in Table E13-E32 below:

TABLE E13-E32

| | PPHR, | Wt % in Blowing Agent | | | | | | Aged |
|---|---|---|---|---|---|---|---|---|
| Ex. | BA in | | | | | CO2 or Water | Density | Lambda, |
| No. | melt | 134a | 1233zd | iC4 | DME | or Ethanol | (kg/m3) | mW/mK |
| E13 | 8.5 | 35 | 50 | 15 | 0 | 0 | <37 | =<29.5 |
| E14 | 8.5 | 65 | 15 | 20 | 0 | 0 | <37 | =<29.5 |
| E15 | 8.5 | 65 | 15 | 15 | 5 | 0 | <37 | =<29.5 |
| E16 | 8.5 | 65 | 15 | 15 | 0 | CO2 - 5 | <37 | =<29.5 |
| E17 | 8.5 | 65 | 15 | 15 | 0 | Water - 5 | <37 | =<29.5 |
| E18 | 8.5 | 65 | 15 | 15 | 0 | Ethanol - 5 | <37 | =<29.5 |
| E19 | 8.5 | 65 | 15 | 15 | 1-5 | CO2 - 1-5 | <37 | =<29.5 |
| E20 | 8.5 | 65 | 15 | 15 | 1-5 | Water - 1-5 | <37 | =<29.5 |
| E21 | 8.5 | 65 | 15 | 15 | 1-5 | Ethanol - 1-5 | <37 | =<29.5 |
| E22 | 8.5 | 55 | 30 | 15 | 0 | 0 | <37 | =<29.5 |
| E23 | 8.5 | 55 | 30 | 12.5 | 2.5 | 0 | <37 | =<29.5 |
| E24 | 8.5 | 55 | 30 | 12.5 | 0 | CO2 - 2.5 | <37 | =<29.5 |
| E25 | 8.5 | 55 | 30 | 12.5 | 0 | Water - 2.5 | <37 | =<29.5 |
| E26 | 8.5 | 55 | 30 | 12.5 | 0 | Ethanol - 2.5 | <37 | =<29.5 |
| E27 | 8.5 | 60 | 25 | 15 | 0 | 0 | <37 | =<29.5 |
| E28 | 8.5 | 60 | 25 | 12.5 | 2.5 | 0 | <37 | =<29.5 |
| E29 | 8.5 | 60 | 25 | 12.5 | 0 | CO2 - 2.5 | <37 | =<29.5 |
| E30 | 8.5 | 60 | 25 | 12.5 | 0 | Water - 2.5 | <37 | =<29.5 |
| E31 | 8.5 | 60 | 25 | 12.5 | 0 | Ethanol - 2.5 | <37 | =<29.5 |
| E32 | 8.5 | 35 | 50 | 15 | 0 | 0 | <37 | =<29.5 |

As can be seen from Table E13-E32, applicants have unexpectedly found that certain blowing agents can be formulated based on a combination of HFC-134a, 1233zd(E) and isobutane, both without and with DME and/or CO2 and/or water and/or ethanol, which are able to achieve thermoplastic foams having density and aged lambda values within the requirements outlined herein.

What is claimed is:

1. A method for forming extruded polystyrene foam comprising:
(a) providing a thermoplastic polystyrene melt comprising thermoplastic polystyrene and a blowing agent comprising:
i. from about 10% by weight to about 30% by weight of HCFO-1233zd(E);
ii. from about 35% by weight to about 75% by weight of HFC-134a;
iii. from about 10% to about 35% by weight of isobutane; and
iv. optionally a fourth component comprising up to about 20% by weight of dimethyl ether and/or carbon dioxide and/or water and/or ethanol or a combination of two or more of these,
wherein the amount of components (i)-(iv) in the blowing agent is not less than about 95% by weight of all the blowing agent components in the formulation; and
(b) foaming the thermoplastic material by steps including extruding said thermoplastic polystyrene melt to produce extruded polystyrene foam.

2. The method of claim 1 wherein said blowing agent comprises:
(i) from about 10% by weight to about 30% by weight of HCFO-1233zd(E);
(ii) from about 55% by weight to about 75% by weight of HFC-134a;
(iii) from about 20% to about 35% by weight of isobutane; and
(iv) optionally a fourth component comprising up to about 20% by weight of dimethyl ether and/or carbon dioxide.

3. The method of claim 1 wherein the extruded polystyrene foam has a density of about 40 kg/m³ or less and an aged thermal conductivity of 30 mW/mk or less.

4. The method of claim 1 wherein the amount of (i)-(iv) in the blowing agent is not less than about 97% by weight.

5. The method of claim 1 wherein said blowing agent consisting essentially of:
i. from about 10% by weight to about 30% by weight of HCFO-1233zd(E);
ii. from about 35% by weight to about 65% by weight of HFC-134a; and
iii. from about 10% to about 30% by weight of isobutane.

6. The method of claim 1 wherein the extruded polystyrene foam has a density of about 37 kg/m³ or less and an aged thermal conductivity of 29.5 mW/mK or less.

7. The method of claim 1 wherein the extruded polystyrene foam has a density of about 36 kg/m³ or less and an aged thermal conductivity of 30 mW/mK or less.

8. The method of claim 1 wherein the extruded polystyrene foam has a density of about 36 kg/m³ or less and an aged thermal conductivity of 29.5 mW/mK or less.

9. The method of claim 1 wherein the extruded polystyrene foam has a density of about 36 kg/m³ or less and an aged thermal conductivity of 29 mW/mK or less.

10. The method of claim 1 wherein the extruded polystyrene foam has a density of about 35 kg/m³ or less and an aged thermal conductivity of 30 mW/mk or less.

11. A blowing agent comprising:
(a) from about 10% by weight to about 35% by weight of HCFO-1233zd(E);
(b) from about 35% by weight to about 70% by weight of HFC-134a;
(c) from about 10% to about 30% by weight of isobutane; and
(d) optionally up to about 15% by weight of a fourth component comprising dimethyl ether and/or carbon dioxide and/or water and/or ethanol or a combination of two or more of these,
wherein the amount of components (a)-(d) in the blowing agent is not less than about 95% by weight of all the blowing agents components in the formulation.

12. The blowing agent of claim 11 comprising:
(i) from about 10% by weight to about 30% by weight of HCFO-1233zd(E);
(ii) from about 55% by weight to about 75% by weight of HFC-134a;
(iii) from about 15% to about 25% by weight of isobutane; and
(iv) optionally up to about 15% by weight of a fourth component comprising dimethyl ether and/or carbon dioxide and/or water and/or ethanol or combinations of two or more of these,
wherein components (i)-(iii) comprise together at least 85% by weight of the blowing agent.

13. The blowing agent of claim 11 comprising:
(i) from about 10% by weight to about 30% by weight of HCFO-1233zd(E);
(ii) from about 55% by weight to about 75% by weight of HFC-134a;
(iii) from about 15% to about 25% by weight of isobutane; and
(iv) optionally up to about 10% by weight of a fourth component dimethyl ether and/or carbon dioxide and/or water and/or ethanol or combinations of two or more of these,
provided that components (i)-(iii) comprise together at least 90% by weight of the blowing agent.

14. The blowing agent of claim 11 comprising:
(i) from about 10% by weight to about 30% by weight of HCFO-1233zd(E);
(ii) from about 55% by weight to about 75% by weight of HFC-134a;
(iii) from about 15% to about 35% by weight of isobutane; and
(iv) optionally up to about 10% by weight of a fourth component comprising dimethyl ether and/or carbon dioxide and/or water and/or ethanol or combinations of two or more of these,
wherein components (i)-(iii) comprise together at least 90% by weight of the blowing agent.

15. The blowing agent of claim 11 comprising:
(i) from about 10% by weight to about 30% by weight of HCFO-1233zd(E);
(ii) from about 55% by weight to about 65% by weight of HFC-134a;
(iii) from about 15% to about 25% by weight of isobutane; and
(iv) optionally up to about 10% by weight of a fourth component comprising dimethyl ether and/or carbon dioxide and/or water and/or ethanol or combinations of two or more of these,
wherein components (i)-(iii) comprise together at least 90% by weight of the blowing agent.

16. A thermoplastic foam comprising:
(a) a thermoplastic polymer comprising a plurality of closed cells; and
(b) gaseous material contained in said plurality of said closed cells, said gaseous material comprising:
i. from about 10% by weight to about 35% by weight of HCFO-1233zd(E);
ii. from about 35% by weight to about 70% by weight of HFC-134a;
iii. from about 10% to about 30% by weight of isobutane; and
iv. optionally up to about 15% by weight of a fourth component comprising dimethyl ether and/or carbon dioxide and/or water and/or ethanol or a combination of two or more of these,
wherein the amount of components (a)-(d) in said gaseous material is not less than about 85% by weight of all the components in the gaseous material.

17. The foam of claim 16 wherein said foam is an extruded polystyrene foam having a density of about 40 kg/m³ or less and an aged thermal conductivity of 30 mW/mk or less.

18. The foam of claim 16 wherein said foam is an extruded polystyrene foam having a density of about 37 kg/m³ or less and an aged thermal conductivity of 30 mW/mk or less.

19. The foam of claim 16 wherein said foam is an extruded polystyrene foam having a density of about 36 kg/m³ or less and an aged thermal conductivity of 30 mW/mk or less.

20. The foam of claim 16 wherein said foam is an extruded polystyrene foam having a density of about 35 kg/m³ or less and an aged thermal conductivity of 29.5 mW/mk or less.
